(19) United States
(12) Patent Application Publication
(10) Pub. No.: US 2012/0229291 A1
(43) Pub. Date: Sep. 13, 2012

(54) Method and Device for Securing Operation of Automatic or Autonomous Equipment

(76) Inventors: Kenneth Mikalsen, Bryne (NO); Roald Valen, Kleppe (NO)

(21) Appl. No.: 13/509,540

(22) PCT Filed: Mar. 4, 2011
(86) PCT No.: PCT/NO2011/000076

§ 371 Date: May 11, 2012

(30) Foreign Application Priority Data
Mar. 10, 2010 (NO) 20100339

(51) Int. Cl. G08B 21/00; G06F 15/00

(52) U.S. Cl. 340/686.6; 702/150

(57) ABSTRACT

A method and device for securing operation of automatic or autonomous equipment where the equipment comprises a component being displaced a space, and where the method comprises:—to calculate the component position in the space by means of data from the component control system, and where the method further comprises:—to measure non-contact wise the component real position; and—to calculate a deviation between the calculated position and the real position.

There is provided a method for securing operation of automatic or autonomous equipment. More particularly it concerns a method for securing operation of automatic or autonomous equipment where the equipment comprises a component being spatially displaced, and where the method includes calculating the component position in the space by means of data from the component control system. The invention also comprises a device for performing the method.

Position reporting of components belonging to automatic or autonomous equipment is according to prior art based on data from the respective control systems of the components. The position report thus represents a calculated position. The control systems steers the components to the desired positions to accomplish the work operations to be implemented. It is common to work with a 3D model of the equipment to also be able to represent the component visually. The 3D model, being continuously updated, is checked continuously, for example to avoid collision between different components.

Verification of the calculated positions can be difficult, particularly in areas difficult to access. If components are damaged or comes loose this may lead to positional deviations difficult to register by means of the control system of the component itself.

Errors of this kind may result in unforeseen, unfortunate and undesirable incidents.

The object of the invention is to remedy or reduce at least one of the disadvantages of the prior art, or at least to provide a useful alternative to the prior art.

The object is achieved by the features disclosed in the below description and in the subsequent claims.

There is provided a method for securing operation of automatic or autonomous equipment where the equipment comprises a component being displaced in a space, and where the method includes:
to calculate the component's position (calculated position) in the space by means of data from the component control system, and where the method is characterized in that it comprises:
to measure non-contact wise the real component position; and
to calculate a deviation between the calculated position and the real position.

By calculated position is meant here a position calculated based on a 3D model of the equipment where “are”—values supplied to the control system from transmitters fitted on or at the relevant component is used. This gives an essentially more reliable calculated position than by use of “shall”—values for the relevant components where one bases it on the set values for the component being realized. In that more positions on the component are calculated, the component's spatial orientation is also calculated.

The component's position may be measured non-contact, typically by reflection of energy waves, for example in the form of visible light being intercepted by a camera. Energy waves in other frequency areas may, depending on the actual conditions, be relevant.

The method may further comprise filtering of data for the calculated position and data for the real position in the same way before the deviation is calculated. The filtering is explained more closely in the specific part of the application.

The method may comprise giving off a warning when the deviation exceeds a predetermined value.

The method may comprise showing a calculated picture of the component based on calculated position and showing a real picture of the component based on the measured position. The measured picture may be shown superimposed on the calculated picture or vice versa.

In a simple, visual form a picture produced by means of a camera is superimposed on a calculated 2D picture of the same area, whereby deviations will immediately be visible. A thus simplified method will however not be able to calculate deviations between the pictures.

It is thus necessary to treat both signals for the calculated position and for the real position to make them comparable, see the specific part of the application.

The method may be performed by means of a processing unit for automatic or autonomous equipment where the equipment comprises a component being spatially displaced a, and where a machine and a manipulator is controlled via a control system arranged to be able to give off a signal comprising calculated spatial position of a component, and where a non-contact transmitter is arranged to be able to give off a signal comprising a real spatial position for the component, and where the signals from the control system and the non-contact transmitter are converted in a refining module for calculated position and a refining module for real position, respectively, to comparable picture information.

The comparable picture information from the refining module for calculated position and the refining module for real position may be compared in a deviation module, as the deviation module is arranged to be able to give off a warning if the deviation is larger than a predetermined value.

The method and the device according to the invention makes secure monitoring and warning possible on deviations for automatic and autonomous equipment located for example in inaccessible places such as the seabed, or in areas where operator presence may be associated with danger. There may be presented pictures from different angles as non-contact transmitters may be positioned in different positions to intercept events in the space. Full 3D surveillance of the space where a number of active and passive machines are located, is thus possible by means of appropriately placed non-contact transmitters.

In the following is described an example of a preferred method and device illustrated in the accompanying drawings, where:

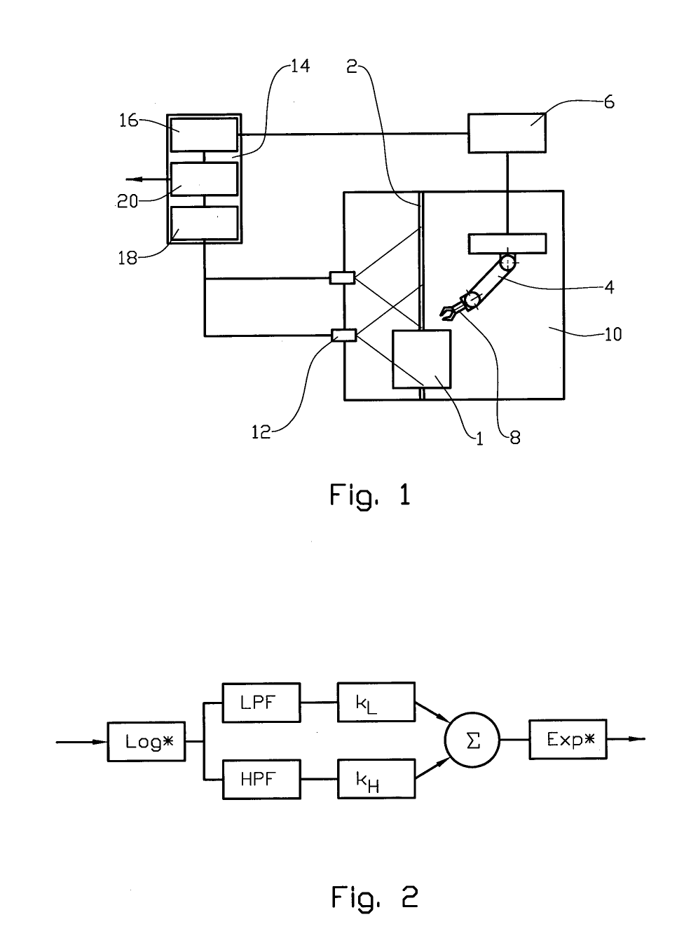

FIG. 1 shows a layout of equipment according to the invention;

FIG. 2 shows a flow diagram for weighting of reflectance and light intensity; and

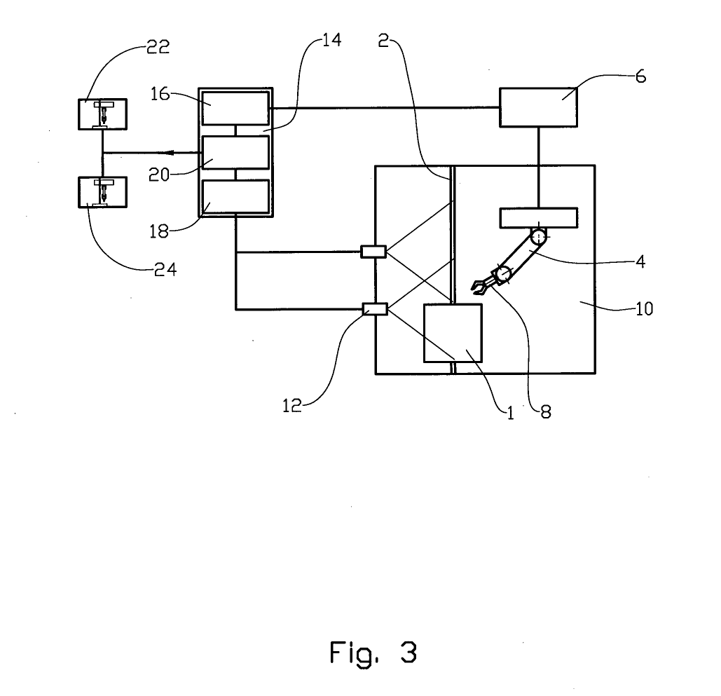

FIG. 3 shows the same as in FIG. 1, but where pictures of calculated position and real position are shown.

In the drawings the reference number 1 indicates a machine in a process, for example for treatment of a pipe string 2. The machine 1 is operated by a manipulator 4 which may be controlled manually, automatically, or autonomously by or via a control system 6.

The manipulator 4 is provided with a component 8, here in the form of a gripper, which is displaceable in the space 10.

The space 10 is lit by means of not shown lamps. A number of non-contact transmitters 12, here in the form of cameras, monitor the space 10 from different positions.

The control system 6 comprises a program arranged to be able to provide the necessary information for building a 3D model of the manipulator 4. The 3D model is dynamic in the sense that it is continuously updated to be able to show the actual position of the component 8. Information about the machine 1 and the space 10 is also included in the 3D model. A control and simulation program marketed under the name “Actin” by Energid Technologies Corporation, Cambridge, Mass., USA has turned out to be suitable for both control of the manipulator and to render graphically calculated spatial positions for a component 8. The “Actin” technique is described in U.S. Pat. No. 6,757,587.

From the control system 6 the information about the calculated position of the component 8 is led to a processing unit 14 where said information is processed in a refining module for calculated position 16.

The signals from the control system 6 and from the non-contact transmitters 12 are converted in the refining module for a calculated position 16 and a refining module for a real position 18, respectively, for comparable picture information. The comparison is undertaken in a deviation module 20. A picture 22 based on a calculated position and a picture 24 based on a real position may be shown, see FIG. 3.

Pictures from different angles may be presented, as non-contact transmitters 12 may be located in different positions to intercept events in the space 10. The refining modules 16, 18 may present a series of pictures to the deviation module for example from the number of non-contact transmitters 12. Full 3D surveillance of the space is thus possible by means of suitably located non-contact transmitters 12.

An identification and localisation program marketed under the name “Selectin” by Energid Technologies Corporation comprises a part of the algorithm necessary to be used in the refining modules 16 and 18. “Selectin” thus forms a basis for the software developed to be able to compare the calculated position with the real position. The “Selectin” technique is described in U.S. patent application Ser. No. 11/141,843.

The comparison is performed at pixel level for individual pixels and/or group of pixels. In that several pixels from the calculated position normally is compared to corresponding pixels from the real position, the orientation of the component in the space 10 is simultaneously determined.

The signals fed to the refining modules 16, 18 may contain errors. For example occurs distortion, pixel noise and loss of contrast from the non-contact transmitters. These errors are not present in the signal from the control system 6. Also occurring is that the 3D model is incomplete or that the transmission is faulty.

In the refining module for the calculated position 16 and the refining module for the real position 18 is therefore performed signal refining which may comprise removal of pixel noise, normalisation of contrast, normalisation of intensity, correction for objective distortion, and blocking of areas having non-relevant deviations. Both the calculated positions and the actual positions are updated continuously at the same time as relevant features are calculated and amplified.

Pixel noise is removed by so-called median filtering, which is a non-linear technique. See R. Boyle and R. Thomas: Computer Vision: A First Course, Blackwell Scientific Publications, 1988, pp 32-34.

The contrast is normalised by means of so-called homomorphous filtering, which also removes so-called artefacts. By artefacts is meant undesired, often artificial effects of light setting. See http://homepages.inf.ed.ac.uk/rbf/Cvonline/LOCAL COPIES/OWENS/LECT5/node4.html for further explanation.

A main task in the refining is to remove undesired artefacts coming from the lighting. The intensity f(i,j) of a pixel i,j in a picture may be represented by f(i,j)=i(i,j)r(i,j) where r(i,j) is a measure of the observed reflectance from an observed surface, and i(i,j) is the intensity of the lighting on the observed surface.

The reflectance (spectral properties) varies generally at a higher spatial rate than the lighting. Spatial rate is change related to a displacement over a distance as opposed to velocity. If one for example has a sequence of pictures like in a video stream, there may occur temporary changes in a pixel from one picture to the next, and spatial changes are from one pixel to the next in the same picture.

It is desirable to suppress the effect of the lighting because it does not contribute information to identify physical deviations. A logarithmic operator, log*( ), may be employed to split the intensity and the reflectance to suppress or reduce the effect of variation in the light intensity.

log*{(f(i(i,j)}≈log*{(r(i,j)}+log *{(r(i,j)}

On the assumption that the lighting intensity is changed slowly and that the surface properties, represented by the reflectance, are changed rapidly, the light intensity may be emphasized by means of low pass filtration and the surface properties emphasized by means of high pass filtration of the log-transformed values.

By multiplying the low-pass filtered signal, LPF, by a factor k_{L} being smaller than 1, and the high-pass filtered signal, HPF, by a factor k_{H} being larger than 1, the surface properties are emphasized at the cost of the light intensity.

The log* function and an exp* function: exp*{log*(X)}=x, maps the area 0-255 over in 0-255 approximate, respective logarithmic and exponential functions, see FIG. 2. 0-255 is chosen because this area may be represented by a single byte, which is the most common picture representation.

Other known methods may to a necessary degree be used for further signal treatment in addition to median and homomorphous filtering. Extensible Markup Language XML has turned out to be suitable for assembling of different filter components.

For picture deviation a weighted n-norm on pixel for pixel difference between the refined, calculated position and the refined actual position turned out to be suitable. The homomorphous filtering moderates undesired appearance changes caused by lighting. These are changes not taken into account. It is not desirable in filtering to introduce artificial changes between the calculated and the real picture. The filtering is therefore done before the pictures are compared.

Deviation calculations are as earlier mentioned made over different areas of the equipment. The two-norm method (the sum of squares) has turned out to be suitable to detect differences, but other known methods, such as the sum of absolute pixel differences or the sum of the fourth power of the differences, may function satisfactorily.

Calibrating the calculated position and the real position constitutes a part of the method. Selectin's “Refined Type, Pose, Geometry” (RTPG) processor is used to decide how best to decide deviations between the calculated position and the actual position. RTPG utilises DAK models for the machine 1, the manipulator 4 and the space 10 together with actual position data for repeatedly to give off and subsequently change the picture information to best fit with the transformed data from the non-contact transmitters.

1. A method for securing operation of automatic or autonomous equipment where the equipment comprises a component being displaced in a space, and where the method comprises:
calculating the component's position in the space by means of data from the component control system;
measuring non-contact wise the component is real position; and
calculating a deviation between the calculated position and the real position of the component.

2. The method according to claim 1, wherein the method further comprises filtering data for the calculated position and data for the real position in the same manner before deviation is calculated.

3. The method according to claim 1, wherein the method further comprises giving off a warning when the deviation exceeds a predetermined value,

4. The method according to claim 1, characterized in that wherein the method further comprises showing a picture of the component based on the calculated position (calculated picture); and
showing a picture of the component based on the measured position (measured picture).

5. The method according to claim 3, wherein the method further comprises showing the measured picture superimposed on the calculated picture.

6. A device for a processing unit for automatic or autonomous equipment where the equipment comprises a component being displaced in a space, the device comprising a control system for controlling a machine and a manipulator, the control system arranged to give off a signal comprising a calculated position of the component in the space;
a non-contact transmitter is arranged to give off a signal comprising a real position for the component in the space;
a refining module for converting the signals from the control system and from the non-contact transmitter for calculated position into comparable picture information; and
a refining module for converting the signals from the control system and from the non-contact transmitter for real position, into comparable picture information.

7. The device according to claim 6, wherein the comparable picture information from the refining module for calculated position and the refining module for real position are compared in a deviation module, and wherein the deviation module is arranged to give off a warning if the deviation is larger than a predetermined value.
